(19) United States
(12) Patent Application Publication
(10) Pub. No.: US 2026/0112908 A1
(43) Pub. Date: Apr. 23, 2026

(54) BATTERY SYSTEM

(71) Applicant: TOYOTA JIDOSHA KABUSHIKI KAISHA, Toyota-shi (JP)

(72) Inventors: Takashi OGURA, Seto-shi (JP); Hiroshi Yoshida, Anjo-shi (JP); Yuki Sugo, Seto-shi (JP)

(73) Assignee: TOYOTA JIDOSHA KABUSHIKI KAISHA, Toyota-shi (JP)

(21) Appl. No.: 19/308,847

(22) Filed: Aug. 25, 2025

(30) Foreign Application Priority Data
Oct. 22, 2024 (JP) 2024-186122

(51) Int. Cl. H02J 7/00; H01M 10/052

(52) U.S. Cl. CPC H02J 7/825; H02J 7/947; H02J 7/977; H01M 10/052

(57) ABSTRACT

An ECU executes a process including the steps of: acquiring parameters; calculating an integrated value Q1 of a charging current when detection of a step is not confirmed; acquiring the temperature of each cell when detection of a step is confirmed; calculating an integrated value Q2 of the charging current until charging is completed; once the charging is completed, calculating a correction factor C; and calculating a full charge capacity.

### CROSS-REFERENCE TO RELATED APPLICATION

This application claims priority to Japanese Patent Application No. 2024-186122 filed on Oct. 22, 2024. The disclosure of the above-identified application, including the specification, drawings, and claims, is incorporated by reference herein in its entirety.

### BACKGROUND

### 1. Technical Field

The present disclosure relates to battery systems.

### 2. Description of Related Art

For example, Japanese Unexamined Patent Application Publication No. 2003-164006 (JP 2003-164006 A) discloses a technique in which the degradation level of a battery is calculated from voltage and current values, the capacity adjustment range is corrected according to the calculated degradation level, and the current battery capacity is displayed using segments.

### SUMMARY

As in the above technique, one possible way to calculate the current capacity of a battery is to estimate the full charge capacity based on a step-like change in the open circuit voltage (OCV) of the battery. However, in situations such as low temperatures, the position of the step-like change may shift, which can lead to a decrease in accuracy of the estimation of the full charge capacity.

The present disclosure has been made to address the above issue, and an object thereof is to provide a battery system that accurately estimates the full charge capacity even in situations such as low temperatures.

A battery system according to an aspect of the present disclosure is a battery system including a control device configured to perform control regarding charging of a battery including a lithium iron phosphate battery. The control device is configured to, when a step is detected in a change in the OCV of the battery during charging of the battery, calculate a full charge capacity of the battery by setting a correction factor using a first integrated value and the temperature of the battery, calculating a sum of a predetermined value and a second integrated value, and multiplying the sum by the correction factor. The first integrated value is an integrated value of a current flowing through the battery from the start of the charging of the battery to detection of the step. The second integrated value is an integrated value of the current flowing through the battery from the detection of the step to completion of the charging of the battery.

In this configuration, the full charge capacity of the battery is calculated by correcting the sum of the second integrated value and the fixed value by the correction factor that is set using the first integrated value and the temperature of the battery. Therefore, the full charge capacity can be accurately estimated.

In one embodiment, the control device is configured to, when the temperature of the battery is low, set the correction factor such that the full charge capacity becomes smaller than the sum of the predetermined value and the second integrated value, compared to when the temperature is high.

In this configuration, an appropriate correction factor is set according to the temperature of the battery. Therefore, the full charge capacity can be accurately estimated.

In another embodiment, the control device is configured to set the correction factor using the degradation level of the battery in addition to the first integrated value and the temperature of the battery.

With this configuration, the full charge capacity of the battery can be more accurately estimated based on the correction factor that is set using the degradation level of the battery in addition to the first integrated value and the temperature of the battery.

In still another embodiment, the control device is configured to, when the degradation level of the battery is high, set the correction factor such that the full charge capacity becomes smaller than the sum of the predetermined value and the second integrated value, compared to when the degradation level of the battery is low.

In this configuration, the correction factor is appropriately set according to the degradation level of the battery. Therefore, the full charge capacity can be accurately estimated.

In yet another embodiment, the predetermined value is a value corresponding to the first integrated value when the battery is not degraded and is at room temperature.

With this configuration, the full charge capacity can be accurately estimated based on the second integrated value from detection of the step to completion of the charging of the battery and the correction factor.

According to the present disclosure, it is possible to provide a battery system that accurately estimates the full charge capacity even in situations such as low temperatures.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of the overall configuration of an electrified vehicle equipped with a battery system according to an embodiment;

FIG. 2 shows graphs illustrating the relationship between the OCV and the remaining capacity of a cell according to the embodiment;

FIG. 3 is a graph showing an example of how the OCV changes with respect to the remaining capacity at different temperatures;

FIG. 4 is a flowchart showing an example of a process that is executed by an electronic control unit (ECU);

FIG. 5 shows the relationship among a battery temperature, an integrated value, and a correction factor; and

FIG. 6 is a graph illustrates the relationship between the degradation level of a battery and the position of a step.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

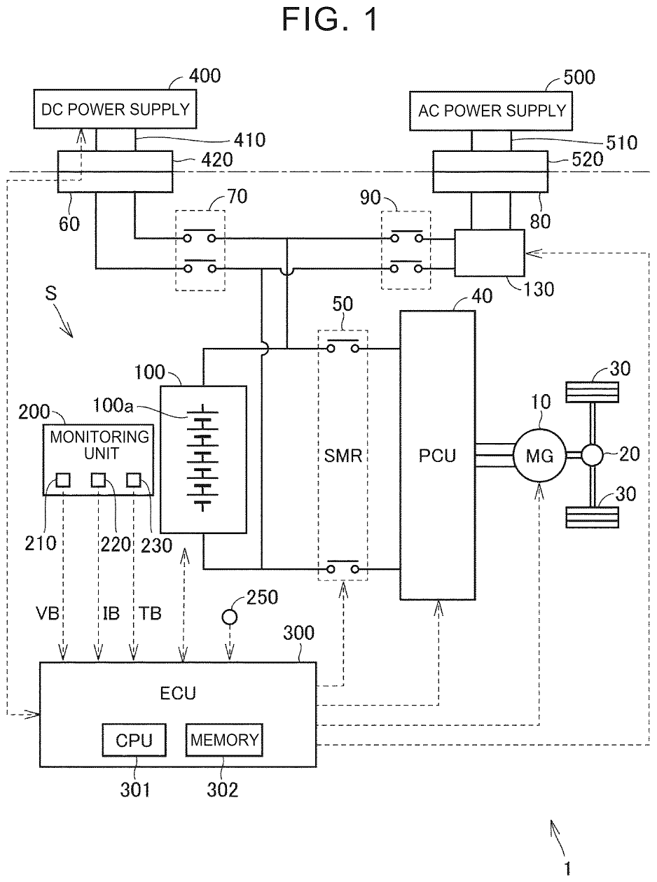

FIG. 1 shows an example of the overall configuration of an electrified vehicle 1 equipped with a battery system S according to the present embodiment. In the present embodiment, the electrified vehicle 1 is, for example, a battery electric vehicle. The electrified vehicle 1 includes a motor generator (MG) 10 that is a rotating electrical machine, a power transmission gear 20, drive wheels 30, a power control unit (PCU) 40, a system main relay (SMR) 50, a battery 100, a monitoring unit 200, and an electronic control unit (ECU) 300. The ECU 300 is an example of the control device.

The MG 10 is, for example, an interior permanent magnet synchronous motor (IPM motor) and serves as both an electric motor and a generator. The output torque of the MG 10 is transmitted to the drive wheels 30 via the power transmission gear 20 that includes a reduction gear and a differential gear.

When the electrified vehicle 1 is braking, the MG 10 is driven by the drive wheels 30 and operates as a generator. Accordingly, the MG 10 also serves as a braking device that performs regenerative braking to convert the kinetic energy of the electrified vehicle 1 to electric power. Regenerative power generated by the regenerative braking force of the MG 10 is stored in the battery 100.

The PCU 40 is a power conversion device that bidirectionally converts electric power between the MG 10 and the battery 100. The PCU 40 includes, for example, an inverter and a converter that operate based on control signals from the ECU 300.

During discharge of the battery 100, the converter boosts the voltage supplied from the battery 100 and supplies the boosted voltage to the inverter. The inverter converts the direct current power supplied from the converter to alternating current power to drive the MG 10.

During charging of the battery 100, the inverter converts the alternating current power generated by the MG 10 to direct current power and supplies the direct current power to the converter. The converter steps down the voltage supplied from the inverter to a level suitable for charging the battery 100 and supplies the stepped-down voltage to the battery 100.

The SMR 50 is electrically connected to a power line that connects the battery 100 and the PCU 40. When the SMR 50 is closed (ON) in response to a control signal from the ECU 300, electric power can be transferred between the battery 100 and the PCU 40. On the other hand, when the SMR 50 is open (OFF) in response to a control signal from the ECU 300, the electrical connection between the battery 100 and the PCU 40 is interrupted.

The battery 100 stores electric power for driving the MG 10. The battery 100 is a rechargeable direct current power supply (secondary battery). The battery 100 is a stack of a plurality of cells (battery cells) 100a that is, for example, electrically connected in series. The cells 100a may be, for example, lithium-ion cells. In the present embodiment, lithium iron phosphate cells (LFP cells) that use lithium iron phosphate as a cathode active material are used as the cells 100a.

The monitoring unit 200 includes a voltage sensor 210, a current sensor 220, and a temperature sensor 230. The voltage sensor 210 detects the voltage VB of each cell 100a (the voltage VB between the terminals of each cell 100a). The current sensor 220 detects the current IB that is input to or output from the battery 100 (cells 100a). The current IB may be positive (+) when charging the battery 100, and negative (−) when discharging the battery 100. The temperature sensor 230 detects the temperature TB of each cell 100a. The monitoring unit 200 outputs the detection results from each detection unit to the ECU 300.

The electrified vehicle 1 is equipped with a direct current (DC) inlet 60. This allows the battery 100 to be quickly charged from an external direct current (DC) power supply, namely charging equipment. The DC inlet 60 is configured such that a connector 420 provided at the distal end of a charging cable 410 of an external DC power supply (charging equipment) 400 can be connected to the DC inlet 60. A charging relay 70 is electrically connected to a power line that connects the DC inlet 60 and the battery 100. The charging relay 70 selectively supplies and cuts off electric power between the DC inlet 60 and the battery 100 in response to a control signal from the ECU 300. External charging (fast charging) of the battery 100 is executed when the charging relay 70 is closed.

The electrified vehicle 1 is equipped with an alternating current (AC) inlet 80. This allows the battery 100 to be normally charged from an external alternating current (AC) power supply, namely charging equipment. The AC inlet 80 is configured such that a connector 520 provided at the distal end of a charging cable 510 of an external AC power supply (charging equipment) 500 can be connected to the AC inlet 80. An on-board charger 130 is provided on a power line between the AC inlet 80 and the battery 100. The on-board charger 130 converts the alternating current power supplied from the external AC power supply 500 to direct current power and further converts the direct current power to a voltage that can charge the battery 100. A charging relay 90 is electrically connected to a power line that connects the on-board charger 130 and the battery 100. The charging relay 90 selectively supplies and cuts off electric power between the on-board charger 130 and the battery 100 in response to a control signal from the ECU 300. External charging (normal charging) of the battery 100 is executed when the charging relay 90 is closed.

The ECU 300 includes a central processing unit (CPU) 301 and a memory 302 (including a read-only memory (ROM) and a random access memory (RAM)). The ECU 300 controls each device such that the electrified vehicle 1 reaches a desired state, based on signals received from the monitoring unit 200, signals from various sensors, not shown (e.g., an accelerator operation amount signal and a vehicle speed signal), and information such as maps and programs stored in the memory 302. The ECU 300 also executes processes such as a process of estimating full charge capacity during charging. The battery system S includes the battery 100 (cells 100a), the monitoring unit 200, and the ECU 300.

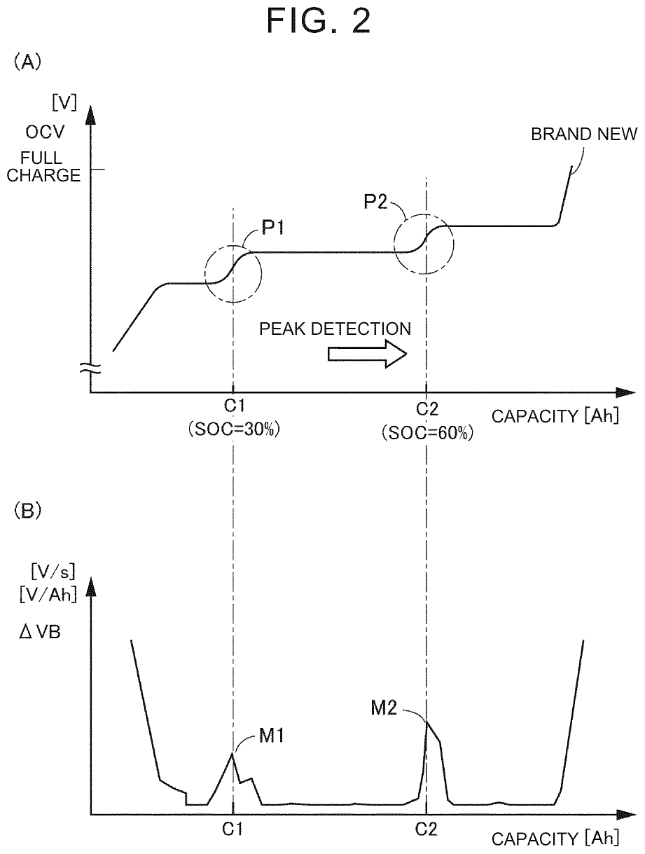

FIG. 2 shows graphs illustrating the relationship between the open circuit voltage (OCV) and the remaining capacity in the cell 100a (LFP cell) of the present embodiment. In part (A) of FIG. 2, the vertical axis represents the OCV (V) of the cell 100a, and the horizontal axis represents the remaining capacity (charge capacity) (Ah) of the cell 100a. As shown in part (A) of FIG. 2, in the relationship between the OCV and the remaining capacity (hereinafter, this relationship will also be referred to as “OCV curve”), there are wide regions where the OCV curve changes very little (flat voltage region). When a point where the OCV curve increases from a flat voltage region and then reaches another flat voltage region is referred to as “step,” there are two steps P1, P2 in the cell 100a of the present embodiment.

The first step P1 (in a lower OCV range) is located at around 30% state of charge (SOC) of a brand-new cell 100a. The second step P2 (in a higher OCV range) is located at around 60% SOC of a brand-new cell 100a.

Part (B) of FIG. 2 shows the relationship between the amount of voltage change ΔVB in voltage VB and the remaining capacity during charging of the battery 100, illustrating the relationship when the battery 100 is charged or discharged at a constant current. The amount of voltage change ΔVB is the amount of change in voltage VB with respect to the remaining capacity (charge capacity) (V/Ah), or the amount of change in voltage VB with respect to time (charge time or discharge time) (V/s). As shown in part (B) of FIG. 2, the amount of voltage change ΔVB reaches a peak value M1 at the remaining capacity corresponding to the step P1, and reaches a peak value M2 at the remaining capacity corresponding to the step P2. Therefore, the remaining capacity at which the amount of voltage change ΔVB reaches the peak value M2 is stored as a reference capacity C2. The full charge capacity of the battery 100 (cell 100a) can be estimated by integrating the charging current from the point where the amount of voltage change ΔVB reaches the peak value M2 until the battery 100 becomes fully charged, and adding this integrated value to the reference capacity C2.

However, for example, in situations such as low temperatures, the position of the step may shift, which can lead to a decrease in accuracy of the estimation of the full charge capacity.

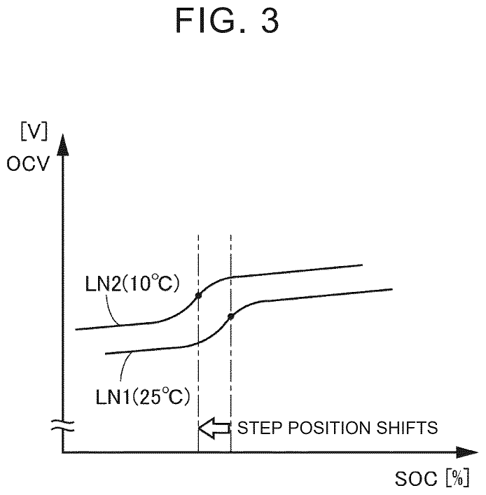

FIG. 3 is a graph showing an example of how the OCV changes with respect to the remaining capacity at different temperatures. The vertical axis in FIG. 3 represents the OCV. The horizontal axis in FIG. 3 represents the SOC. LN1 in FIG. 3 shows an example of how the OCV changes with a change in SOC at room temperature (25° C.). LN2 in FIG. 3 shows an example of how the OCV changes with a change in SOC at 10° C. that is lower than the room temperature. As indicated by LN1 and LN2 in FIG. 3, when the temperature is low, the position where the OCV exhibits a step-like change with respect to the SOC tends to shift toward a lower SOC compared to when the temperature is high. Therefore, when the full charge capacity is estimated from the step P2, the estimation accuracy may decrease depending on the temperature.

Accordingly, in the present embodiment, when the ECU 300 detects a step in a change of the OCV of the battery 100 during charging of the battery 100, the ECU 300 calculates the full charge capacity of the battery 100 by setting a correction factor C using a first integrated value Q1 and the temperature TB of the battery 100, calculating the sum of a second integrated value Q2 and a predetermined value, and multiplying the calculated sum by the correction factor C. The first integrated value Q1 is an integrated value of the current flowing through the battery 100 from the start of the charging of the battery 100 to the detection of the step (hereinafter simply referred to as “integrated value Q1”). The second integrated value Q2 is an integrated value of the current flowing through the battery 100 from the detection of the step to completion of the charging of the battery 100 (hereinafter simply referred to as “integrated value Q2”).

In this case, the full charge capacity of the battery 100 is calculated by correcting the sum of the second integrated value Q2 and the predetermined value by the correction factor C that is set using the first integrated value Q1 and the temperature TB of the battery 100. Therefore, the full charge capacity of the battery 100 can be accurately estimated.

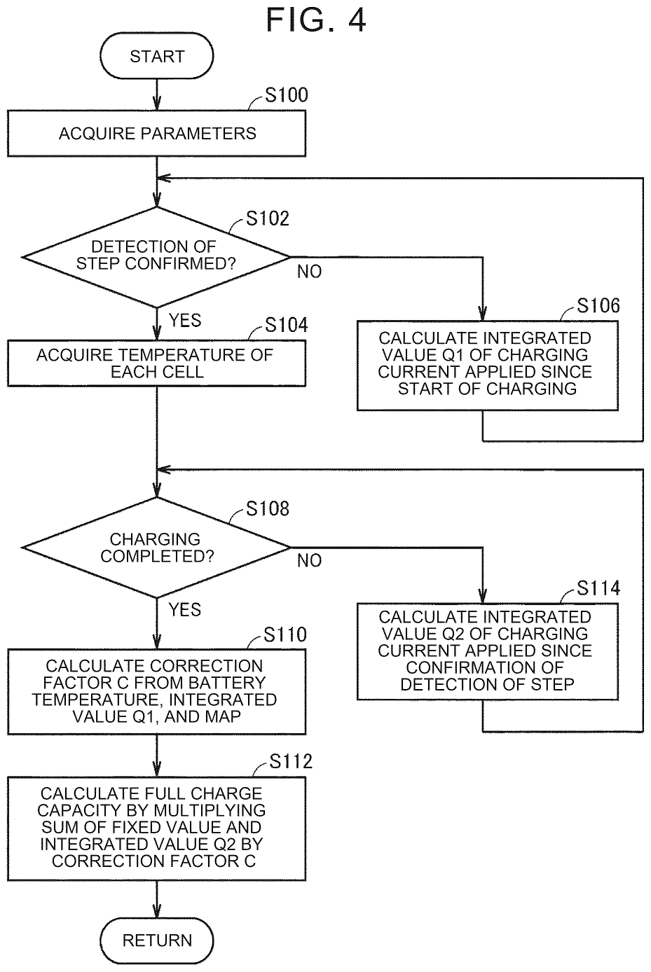

An example of a process that is executed by the ECU 300 will now be described with reference to FIG. 4. FIG. 4 is a flowchart showing an example of the process that is executed by the ECU 300. When the connector 420 is connected to the DC inlet 60, or when the connector 520 is connected to the AC inlet 80, external charging of the battery 100 is started. When external charging of the battery 100 is started, this flowchart is executed for each cell 100a.

In step (hereinafter, the term “step” will be abbreviated as “S”) 100, the ECU 300 acquires parameters. The parameters may include, for example, the voltage VB, current IB, temperature TB, etc. detected by the monitoring unit 200. The process then proceeds to S102.

In S102, the ECU 300 determines whether detection of a step has been confirmed. The ECU 300 determines whether detection of the second step P2 (in a higher OCV range) has been confirmed. The ECU 300 determines that detection of a step has been confirmed when a peak value corresponding to the step P2 is detected in the OCV. More specifically, the ECU 300 may calculate the amount of change ΔOCV in OCV, and may determine that a peak value has been detected when the current amount of change ΔOCV(n) is smaller than the previous amount of change ΔOCV(n−1). Alternatively, the ECU 300 may determine that a peak value has been detected when the sign of the derivative of the amount of change ΔOCV changes from positive to negative. The ECU 300 determines that detection of the step P2 has been confirmed when the SOC of the cell 100a at which a peak value has been detected is greater than a predetermined value (e.g., 50%). The SOC may be measured by, for example, the Coulomb counting method. When it is determined that detection of a step has been confirmed (YES in S102), the process proceeds to S104.

In S104, the ECU 300 acquires the temperature TB of each cell 100a. The process then proceeds to S108. When it is determined that detection of a step has not been confirmed (NO in S102), the process proceeds to S106.

In S106, the ECU 300 calculates an integrated value Q1 of the charging current that has been applied since the start of charging. More specifically, for example, the ECU 300 calculates a current integrated value Q1(n) by adding the charging current ΔQ1 integrated from the previous calculation point to the current calculation point to the previous integrated value Q1(n−1). The process then returns to S102.

In S108, the ECU 300 determines whether charging has been completed. The ECU 300 determines that charging has been completed when the battery 100 becomes fully charged. For example, when the battery 100 is charged by constant current-constant voltage (CCCV) charging, the ECU 300 may determine that the battery 100 is fully charged when the charging current becomes less than or equal to a set value. Alternatively, the ECU 300 may determine that the battery 100 is fully charged when the voltage VB of any one of the cells 100a reaches a charge end voltage. When it is determined that charging has been completed (YES in S108), the process proceeds to S110.

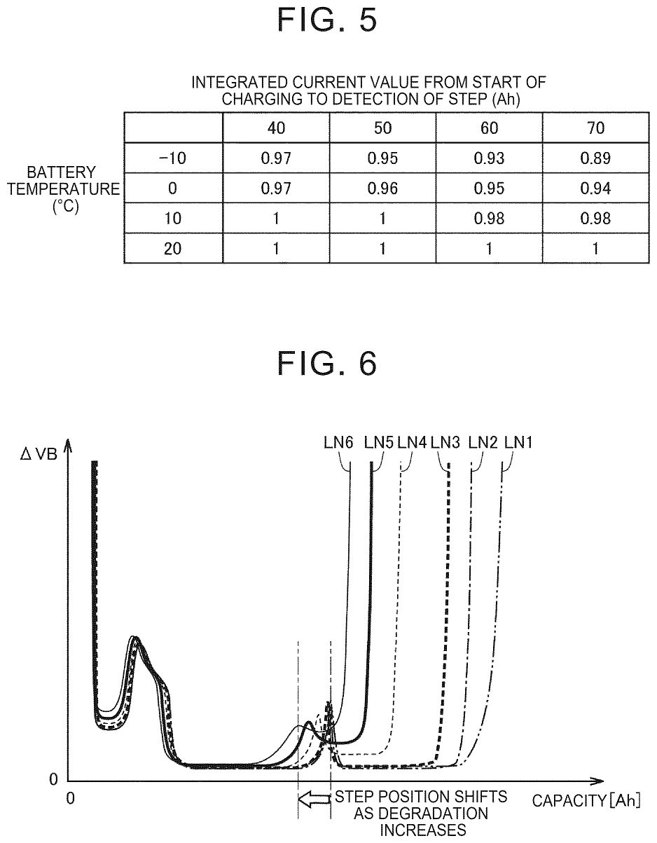

In S110, the ECU 300 calculates a correction factor C from a map showing the relationship among the battery temperature TB, the integrated value Q1, and the correction factor C. FIG. 5 shows the relationship among the battery temperature TB, the integrated value Q1, and the correction factor C. FIG. 5 shows the correction factors C that are set for each combination of a plurality of battery temperatures (−10° C., 0° C., 10° C., and 20° C.) and a plurality of integrated current values (40 Ah, 50 Ah, 60 Ah, and 70 Ah). An integrated current value indicates an integrated value of the current from the start of charging to the confirmation of detection of a step.

For example, when the battery temperature TB is 20° C., the correction factor C is set to “1.0” for all of the integrated current values.

On the other hand, when the battery temperature TB is 10° C., the correction factor C is set to “1.0” when the integrated current value is 40 Ah or 50 Ah, whereas the correction factor C is set to “0.98” when the integrated current value is 60 Ah or 70 Ah.

When the battery temperature TB is 0° C., the correction factor C is set to “0.97” when the integrated current value is 40 Ah, “0.96” when the integrated current value is 50 Ah, “0.95” when the integrated current value is 60 Ah, and “0.94” when the integrated current value is 70 Ah.

When the battery temperature TB is −10° C., the correction factor C is set to “0.97” when the integrated current value is 40 Ah, “0.95” when the integrated current value is 50 Ah, “0.93” when the integrated current value is 60 Ah, and “0.89” when the integrated current value is 70 Ah. The values of the correction factor C corresponding to each parameter (battery temperature TB and integrated current value) shown in FIG. 5 are listed by way of example, and experimentally fitted values etc. may be set as the values of the correction factor C.

The ECU 300 calculates a correction factor C corresponding to the acquired battery temperature TB and the calculated integrated value Q1 by performing linear interpolation etc. using the acquired battery temperature TB, the calculated integrated value Q1, and the map shown in FIG. 5. The process then proceeds to S112.

In S112, the ECU 300 calculates an estimated value of the full charge capacity by multiplying the sum of the integrated value Q2 and a fixed value by the correction factor C. The fixed value is a value corresponding to the integrated value Q1 when the battery 100 (cells 100a) is not degraded and is at room temperature. For example, the fixed value is a predetermined value that has been experimentally fitted. The process then ends. When it is determined that charging has not been completed (NO in S108), the process proceeds to S114.

In S114, the ECU 300 calculates the integrated value Q2 of the charging current that has been applied since the confirmation of detection of a step. More specifically, for example, the ECU 300 calculates a current integrated value Q2(n) by adding the charging current ΔQ2 integrated from the previous calculation point to the current calculation point to the previous integrated value Q2(n−1). The process then returns to S108.

The operation of the ECU 300 of the battery system S of the present embodiment based on the above configuration and flowchart will now be described.

For example, when external charging is started, the OCV of each cell 100a increases as the battery 100 is charged. Various parameters of each cell 100a are acquired (S100), and the SOC is calculated using the acquired parameters. An integrated value Q1 of the charging current that has been applied since the start of external charging is calculated (S106) until detection of a step is confirmed (NO in S102).

Detection of a step is confirmed (YES in S102) when a peak value is detected due to the sign of the amount of change ΔOCV (derivative) in OCV with respect to the SOC changes from positive to negative in a state where the SOC exceeds 50%. When detection of a step is confirmed, the temperature TB of each cell 100a is acquired (S104).

An integrated value Q2 of the charging current that has been applied since the confirmation of detection of a step is calculated (S114) until charging is completed (NO in S108). When the battery 100 becomes fully charged, charging is completed (YES in S108), and a correction factor C is calculated using the acquired battery temperature TB, the integrated value Q1, and the map shown in FIG. 5. An estimated value of the full charge capacity of each cell 100a is calculated by multiplying the sum of the integrated value Q2 and the fixed value by the correction factor C (S110). An estimated value of the full charge capacity of each cell 100a of the battery 100 is calculated in this manner.

As described above, in the battery system S of the present embodiment, the full charge capacity of each cell 100a is calculated by correcting the sum of the integrated value Q2 and the fixed value using the correction factor C that is set using the integrated value Q1 and the temperature TB of the cell 100a. Therefore, the full charge capacity of the battery 100 can be accurately estimated. Accordingly, it is possible to provide a battery system that accurately estimates the full charge capacity even in situations such as low temperatures.

Moreover, when the battery temperature TB is low, the ECU 300 sets the correction factor such that the full charge capacity becomes smaller than the sum of the predetermined value and the integrated value Q2, compared to when the battery temperature TB is high. Therefore, the full charge capacity can be accurately estimated according to the battery temperature TB.

Furthermore, the fixed value is set to the predetermined value corresponding to the integrated value Q1 when the battery is not degraded and is at room temperature. Therefore, the full charge capacity can be accurately estimated using the integrated value Q2 from detection of the step to completion of charging of the battery 100 and the correction factor C.

Hereinafter, modifications will be described.

The above embodiment illustrates an example in which the correction factor C is set using the battery temperature TB and the integrated current value from the start of charging until a step is detected. However, the correction factor C may be set using the degradation level of the cell 100a in addition to the battery temperature TB and the integrated current value.

FIG. 6 is a graph illustrating the relationship between the degradation level of the battery and the position of the step. The vertical axis in FIG. 6 represents the amount of voltage change ΔVB. The horizontal axis in FIG. 6 represents the charge capacity (remaining capacity). LN1 in FIG. 6 shows the relationship between the amount of voltage change ΔVB and the charge capacity of a brand-new cell 100a. LN2 in FIG. 6 shows the relationship between the amount of voltage change ΔVB and the charge capacity of a cell 100a that is more degraded than the cell 100a represented by LN1 in FIG. 6. LN3 in FIG. 6 shows the relationship between the amount of voltage change ΔVB and the charge capacity of a cell 100a that is more degraded than the cell 100a represented by LN2 in FIG. 6. LN4 in FIG. 6 shows the relationship between the amount of voltage change ΔVB and the charge capacity of a cell 100a that is more degraded than the cell 100a represented by LN3 in FIG. 6. LN5 in FIG. 6 shows the relationship between the amount of voltage change ΔVB and the charge capacity of a cell 100a that is more degraded than the cell 100a represented by LN4 in FIG. 6. LN6 in FIG. 6 shows the relationship between the amount of voltage change ΔVB and the charge capacity of a cell 100a that is more degraded than the cell 100a represented by LN5 in FIG. 6. The positions of the peak values at a higher charge capacity in LN1 to LN6 in FIG. 6 are set to the step P2.

As shown by LN1 to LN6 in FIG. 6, as the degradation level of the cell 100a increases, the step P2 shifts toward a lower charge capacity. Therefore, the accuracy of estimating the full charge capacity can be further improved by setting the correction factor C in consideration of the degradation level of the cell 100a.

For example, a map representing the relationship among the battery temperature TB, the integrated current value, and the correction factor C as shown in FIG. 5 is set for each degradation level, and a correction factor C is set from the battery temperature TB and the integrated current value by using an appropriate map corresponding to the degradation level. The full charge capacity can thus be accurately estimated.

For example, when the battery temperature and the integrated current value are the same, it is desirable to set the correction factor C such that the full charge capacity becomes smaller than the sum of the integrated value Q2 and the fixed value when the degradation level is high than when the degradation level is low. In this way, an appropriate correction factor C is set according to the degradation level of the cell 100a. Therefore, the full charge capacity can be accurately estimated.

The embodiment disclosed herein should be considered to be illustrative in all respects and not restrictive. The scope of the present disclosure is set forth by the claims rather than by the above description, and is intended to include all modifications within the meaning and scope equivalent to the claims.

What is claimed is:

1. A battery system including a control device configured to perform control regarding charging of a battery including a lithium iron phosphate battery, wherein the control device is configured to, when a step is detected in a change in an open circuit voltage of the battery during charging of the battery, calculate a full charge capacity of the battery by setting a correction factor using a first integrated value and a temperature of the battery, calculating a sum of a predetermined value and a second integrated value, and multiplying the sum by the correction factor, the first integrated value being an integrated value of a current flowing through the battery from start of the charging of the battery to detection of the step, and the second integrated value being an integrated value of the current flowing through the battery from the detection of the step to completion of the charging of the battery.

2. The battery system according to claim 1, wherein the control device is configured to, when the temperature of the battery is low, set the correction factor such that the full charge capacity becomes smaller than the sum of the predetermined value and the second integrated value, compared to when the temperature is high.

3. The battery system according to claim 1, wherein the control device is configured to set the correction factor using a degradation level of the battery in addition to the first integrated value and the temperature of the battery.

4. The battery system according to claim 3, wherein the control device is configured to, when the degradation level of the battery is high, set the correction factor such that the full charge capacity becomes smaller than the sum of the predetermined value and the second integrated value, compared to when the degradation level of the battery is low.

5. The battery system according to claim 1, wherein the predetermined value is a value corresponding to the first integrated value when the battery is not degraded and is at room temperature.
